(19) United States
(12) Patent Application Publication
(10) Pub. No.: US 2025/0334257 A1
(43) Pub. Date: Oct. 30, 2025

(54) Dual Orientation Lamp Holder

(71) Applicant: Wintergreen Corporation, Alpharetta, GA (US)

(72) Inventors: William Hale, Cumming, GA (US); Richard Chitwood, Cumming, GA (US); Ethan Crawford, Cumming, GA (US)

(73) Assignee: Wintergreen Corporation, Alpharetta, GA (US)

(21) Appl. No.: 19/187,320

(22) Filed: Apr. 23, 2025

Related U.S. Application Data
(60) Provisional application No. 63/638,533, filed on Apr. 25, 2024.

(51) Int. Cl. F21V 21/34; F21V 21/08; F21V 21/30; F21W 131/10

(52) U.S. Cl. CPC F21V 21/34; F21V 21/0824; F21V 21/30; F21W 2131/10

(57) ABSTRACT

A lamp holder includes a first and second opposite J-hooks having opposite openings, where the first J-hook defines an opening having a first horizontal space intersected by a first vertical space and where the second J-hook defines an oppositely facing opening having a second horizontal space intersected by a vertical space. In use, when a light bulb socket having wiring extending from opposite sides is insertable into the lamp holder in a first orientation where the wiring is held in the first and second horizontal spaces, and in a second orientation the wiring is held in the first and second vertical spaces.

### CROSS REFERENCE TO RELATED APPLICATION

This application claims priority to U.S. Provisional Patent Application 63/638,533 filed Apr. 25, 2024, the disclosure of which is hereby incorporated by reference.

### FIELD OF THE DISCLOSURE

The present disclosure relates generally to a lamp holder apparatus including a lamp holder which receives a light bulb socket. The lamp holder is configured for selective orientation of the socket permitting the light bulb therein to be directed either parallel to the lamp holder or orthogonally to an axis of the lamp holder without the need to remove the wire positioned within the lamp holder.

### BACKGROUND OF THE DISCLOSURE

Options are limited when displaying decorative or holiday lighting. Conventional lighting displays do not provide flexibility on the orientation of the bulb, thus requiring that different orientations require different lamp holders. This adds expense when additional lamp holders are required and added storage requirements for alternative lamp holders.

Other lamp holder apparatuses support a socket in more than one position but are cumbersome and time-consuming to alter the direction of the socket and, thus, the light bulb. For example, the lamp holder may be moved, such as pivoted, on the lamp holder apparatus. Another cumbersome option is a lamp holder that receives a socket and wiring, but the socket and wiring must be removed from the lamp holder and reoriented therein, thus being time consuming. Moreover, known apparatuses require securing means for the socket on the lamp holder One aspect is holding the wiring in a secure fashion as opposed to or in addition to holding the socket itself.

### SUMMARY OF THE DISCLOSURE

Presented herein is a lamp holder apparatus including a lamp holder and a support for the lamp holder. The lamp holder overcomes the shortcomings of conventional lighting displays by enabling a single lamp holder which permits selective orientation of the light bulb socket. The lamp holder includes a novel configuration including opposing J-hooks for receiving light bulb wiring whether the light bulb socket is positioned horizontally, vertically, or any orthogonal position therebetween with the lamp holder.

Shortcomings of the prior art are obviated by providing a novel lamp holder including a pair of J-hooks having aligned slots enabling wiring from the light bulb within the socket to extend therethrough when the light bulb socket is positioned vertically or orthogonally relative to the lamp holder. Thus, the lamp holder permits orientation of the light bulb socket, and hence the light bulb, in at least two different orthogonal arrangements or positions without the need to remove the socket or rethread the wiring within the lamp holder. Moreover the present invention is capable of receiving numerous sizes and types of wiring. Additionally, the light bulb socket is maintained in position by securing the wiring to and from the light bulb socket solely in a holder without the need for additional securing members.

### BRIEF DESCRIPTION OF THE DRAWINGS

FIG. 1 is a perspective view of the lamp holder apparatus having a lamp holder and stake according to one aspect;

FIG. 2 is an enlarged, perspective view showing the lamp holder of FIG. 1;

FIG. 3A is a perspective view of a light bulb socket positioned within the lamp holder of FIG. 1 in an exemplary vertical orientation;

FIG. 3B is a perspective view of a light bulb socket positioned within the lamp holder of FIG. 1 in an exemplary horizontal orientation;

FIG. 4 is a cut-away perspective view of the lamp holder apparatus with a lamp holder having J-hooks according to another aspect of the invention;

FIG. 5 is a perspective view of the lamp holder apparatus of FIG. 4 with a light bulb socket positioned within the lamp holder in an exemplary vertical orientation;

FIG. 6 is a top plan view of the lamp holder of FIG. 4;

FIG. 7 is a cut-away perspective view of the lamp holder apparatus with a lamp holder having J-hooks according to another aspect of the invention including additional securing members in the form of detents for mating with light bulb wiring;

FIG. 8 is a cut-away perspective view of the lamp holder apparatus with a lamp holder having J-hooks according to another aspect of the invention including additional securing members in the form of detents for mating with light bulb wiring;

FIG. 9A is a side view of the lamp holder shown in FIG. 8 illustrating different positions of light bulb wiring within the lamp holder; and

FIG. 9B is a side view of the lamp holder shown in FIG. 8 illustrating a different position of different light bulb wiring within the lamp holder.

### DETAILED DESCRIPTION

The present disclosure is understood more readily by reference to the following detailed description, examples, and claims, and their previous and following description. Before the present system, devices, and/or methods are disclosed and described, it is to be understood that the teachings are not limited to the specific systems, devices, and/or methods disclosed unless otherwise specified, as such can, of course, vary. It is also to be understood that the terminology used herein is for the purpose of describing particular aspects only and is not intended to be limiting.

The following description is provided as an enabling teaching in its best, currently known aspect. Those skilled in the relevant art will recognize that many changes and alternatives are made to the aspects described, while still obtaining the beneficial results of the teachings herein. It will also be apparent that some of the desired benefits are obtained by selecting some of the features without utilizing other features or interchanging features variously taught throughout. Accordingly, those who work in the art will recognize that many modifications and adaptations are possible and can even be desirable in certain circumstances and are intended as a part of the present disclosure. Thus, the following description is provided as illustrative of the principles involved and not in limitation thereof.

As used herein, the singular forms “a,” “an” and “the” include plural referents unless the context clearly dictates otherwise. Thus, for example, reference to an “arm” includes aspects having two or more arms unless the context clearly indicates otherwise.

Ranges is expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. As used herein, the term “generally” is used to identify a “general” feature which best describes the feature, even if it is not exact. For example, “generally cylindrical” does not define a precise cylindrical geometric configuration but a configuration that approximates a cylinder.

As used herein, the terms “optional” or “optionally”, “selected” or “selectively” mean that the subsequently described event or circumstance may or may not occur, and that the description includes instances where said event or circumstance occurs and instances where it does not.

As used herein, the terms “proximal” and “distal” (excluding horizontal cross-sections) are used to refer to the axial ends of the lamp holder apparatus and various components. The term “proximal end” refers to the top end adjacent the lamp holder and the term “distal end” refers to the end of the end of lamp holder apparatus adjacent the securing member, or stake end as shown. Structural supports, such as clips or the like, may extend from the lamp holder, albeit not beneath and as used herein, the distal direction includes an outwardly extending support. Also, as used herein, the “axial direction” refers to the longitudinal axis of the lamp holder or lamp holder apparatus, parallel to the center thereof. The term “transverse” direction refers to a direction which intersects the longitudinal axis, at any angle. The term “radial to”, “radially”, “radially inward”, or “radially outward” refers to a direction transverse to the longitudinal axis of the lamp holder; that is inward and outward from the lamp holder apparatus central longitudinal axis. The term “detent” refers to a mechanism, an indentation or protrusion that temporarily keeps one part in a certain position relative to that of another and can be released by applying force to one of the parts.

Although several aspects of the conception are disclosed in the foregoing specification, it is understood by those skilled in the art that many modifications and other aspects will come to mind in areas to which the disclosure pertains, having the benefit of the teaching presented in the foregoing description and associated drawings. It is thus understood that any invention claimed is not limited to the specific aspects disclosed, and that many modifications and other aspects are intended to be included within the scope of the appended claims. Moreover, although specific terms are employed herein, as well as in the claims that follow, they are used only in a generic and descriptive sense, and not for the purposes of limiting the description.

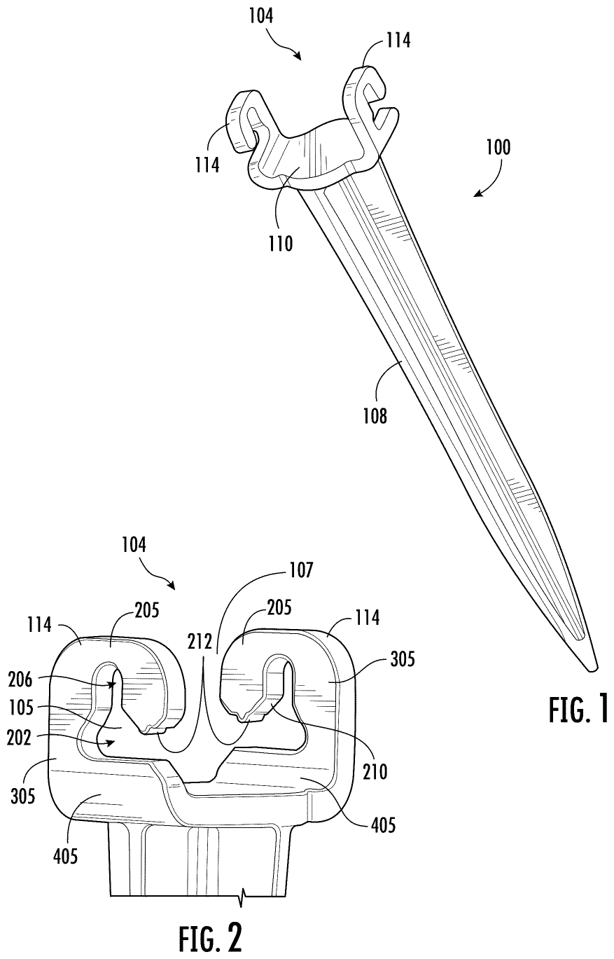

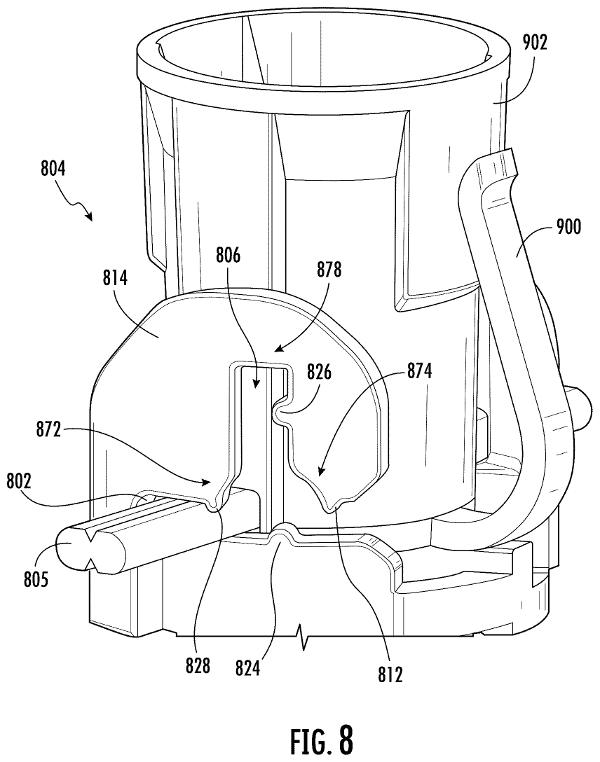

Referring now to the drawings, FIG. 1 is a perspective of an exemplary lamp holder apparatus 100 in form of a stake 108 to hold a lamp and socket securely to, but above ground level. The apparatus 100 comprises at least two parts: a lamp holder 104 connected to or formed integrally with a support, such as a stake 108 as shown in the figures herein. The lamp holder 104 is adjacent a proximal end of the lamp holder apparatus and the stake 108 extends distally from the lamp holder 104. Other structural supports, such as a clip as shown in FIG. 8, would extend outwardly from the lamp holder 104. As used herein, the term “lamp holder” refers to part of the apparatus in the form of J-hooks and the “lamp socket” (for example E12 and E17 base sockets) is retained by the lamp holder to secure it to the lamp holder apparatus 100 in use and is configured to receive a light bulb and the wiring for the lamp bulb when the lamp bulb is on a string of lamps or bulbs. The lamp holder 104 may instead or additionally be connected to or formed integrally with a clip, for example to connect to a gutter, shingle, eave or other roof-top feature. Similarly, the clip may be formed to connect to a fence, tree or shrub, vehicle, vessel, and features where a lamp or string of lamps are desirable. It is within the scope of the present invention to provide a lamp holder 104 supported on structural support other than a stake 108 or even supports used in conjunction with a stake 108. FIG. 8 illustrates a lamp holder 104 that includes a stake 108 and an additional arm 900 which extends from the base of the socket 804.

The lamp holder apparatus 100 includes base 110 (a substantially flat as shown) and the lamp holder 104 comprises opposing “J-hooks” 114 on opposite sides of the base 110.

As further discussed below, when in use the J-hooks 114 hold wiring that extends in and out of a lamp socket. As shown in the figures, lamp sockets are supported above the base 110 and other lamp sockets sit directly on the base, depending upon a variety of factors such as the environment for the light installation. For certain installations, a bump or raised element on the base 110 facilitates drainage and provides separation of at least some of the base of the socket from standing water. This also desirably allows for drainage for sockets with weep holes. Yet another option, the base 110 may itself include holes, weep holes or vias to permit drainage from the base. Additionally, a dot or pimple extending slightly from the top of the base 110 can also help elevate the socket from the base 110 further promoting drainage. According to aspects of the present invention, these features may be provided singularly or in any combination of these features.

As shown in FIGS. 2, 4, and 7, the lamp holder 104, 404, and 704 defines a wire receiving cavity 105. The lamp holder 104, 404, and 704 includes a proximal hook 205, a longitudinal support 305 supporting the proximal hook 205. and a lateral support 405 for connecting the lateral support 405 to the lamp holder base 110. Thus, the proximal hook 205, the longitudinal support 305, and the lateral support 305 define the wire receiving cavity 105 which includes a vertical portion 206 and a horizontal portion 202 which intersect one another to accommodate different sized wires and to orient the socket 302 in more than one orientation. The proximal hook 205 and the longitudinal support 305 define the vertical portion 206 of the cavity 105 and the lateral support 405 and the longitudinal support 305 define the horizontal portion 202 of the cavity 105. The lamp holder 104, 404, 704 includes a wire entry point 107 which serves as the entrance point for a wire into the wire receiving cavity 105.

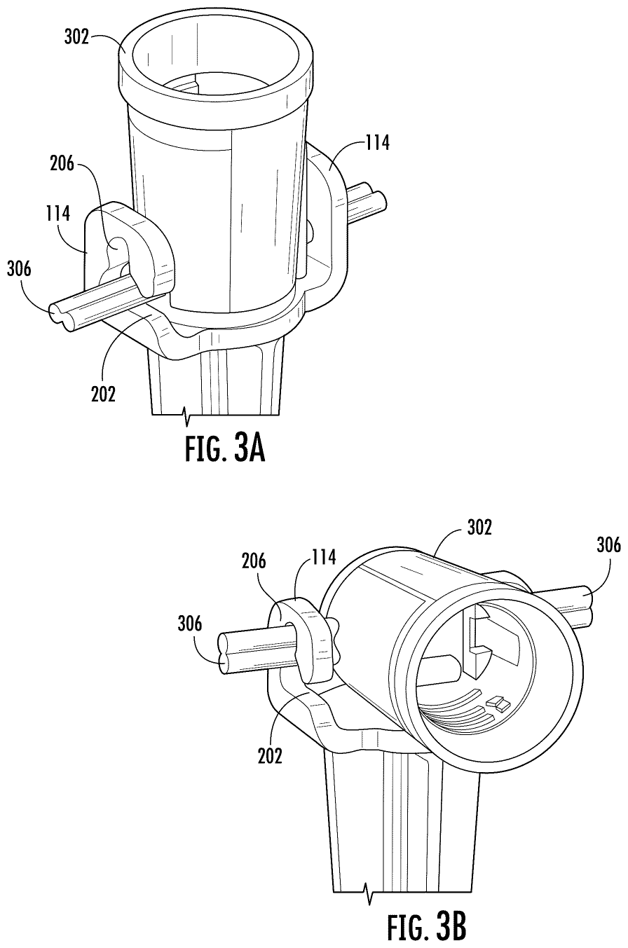

With attention to the J-hooks 114, it can be appreciated that the illustration depicts oppositely oriented hooks 114, with the opening of one oriented opposite the opening of the other. This arrangement helps hold the wiring and socket in place in the lamp holder. As further illustrated below, when wiring (306, FIG. 3) is inserted, the J-hooks 114 secure the wiring in either a horizontally oriented position, in horizontal slot or portion 202, or in a vertically oriented position, in vertical slot or portion 206. Wiring in the horizontal slot 202, will orient the socket (302, FIG. 3) and inserted bulb (not shown) in a vertical or axial relation to the lamp holder 104, thus providing a lamp holder 104 for positioning socket 302 in at least two orientations with the same lamp holder 104. Wiring in the vertical slot 206 shown in FIG. 3B orients the socket 302 in a horizontal or orthogonal relation to the lamp holder 104. J-hook 114 ends include an angled surface 210 to facilitate a user moving the wire between the horizontal and vertical slots 202, 206 allowing the desired orientation of the socket (302, FIG. 3). J-hooks 114 may also include a first detent 212 to further help secure the wiring, in the lamp holder 104 once it has been placed inside.

With reference now to FIGS. 3A and 3B, a socket 302 is depicted in two orientations. FIG. 3A shows the wiring 306 inserted in the J-hooks 114 in the horizontal slot 202 shown FIG. 2. FIG. 3B shows the wiring 306 in the vertical slot 206 shown in FIG. 2. Together, FIGS. 3A and 3B illustrate the duality of the axial or orthogonal orientation of the socket 302. According to all socket orientations, the J-hooks 114 and slots 202/302 accommodate different wire insulation types such as SPT1W, SPT2W and XTW in 18# and 20# wire and possibly 16# with a single lamp holder 104.

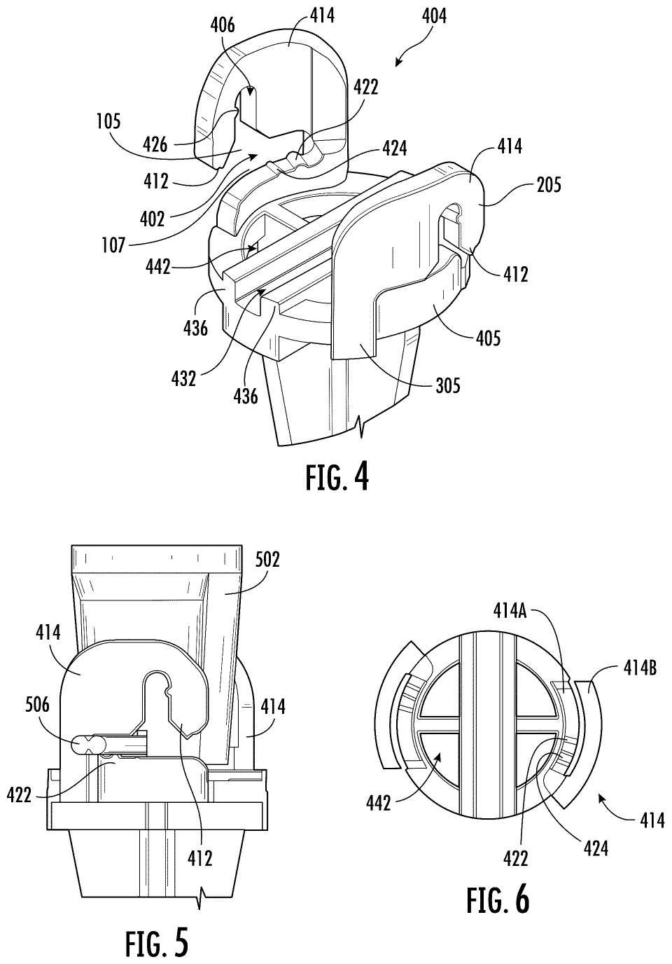

FIG. 4 illustrates a lamp holder 404 according to another aspect of the present invention so securely support the bulb socket 302. With attention to the J-hooks 414, it can be appreciated that the illustration depicts oppositely oriented J-hooks 414, with the opening of one oriented opposite the opening of the other. This arrangement retains the wiring and socket in place in the lamp holder 404. Similarly, when wiring 506, shown in FIG. 5, is inserted, J-hooks 414 can hold the wiring in either a horizontally oriented position, in horizontal slot 402, or in a vertically oriented position, in vertical slot 406 similar to that described above with regard to FIG. 2. Wiring in the horizontal slot 402 will, thus, orient the socket (502, FIG. 5) and inserted bulb in a vertical or axial relation to the lamp holder 404. Wiring in the vertical slot 406 will orient the socket in a horizontal or orthogonal relation to the lamp holder 404 akin to that shown in FIG. 3B (in connection with differently oriented J-hooks 114).

As illustrated, J-hooks 414 may also include additional securing members to secure the wiring firmly in place. For example, J-hooks 414 may also include a detent 412 to further help secure the wiring, in the lamp holder 404. Further, horizontal slot 402 as shown includes a third detent 422, to securely hold, for example, 18# or 20# SPT1W or XTW wire when positioned in between the middle seam of the wire. Since the wire is placed horizontally, the socket will sit in a vertical position. See FIG. 5. Horizontal slot 402 may additionally include another third detent 424 to securely hold, for example, 18# or 16# SPT2W wire when positioned in between the middle seam of the wire. Again, since the wire is placed horizontally, the socket will sit in a vertical position. As an additional example, vertical slot 406 can include at least one other detent, or second detent, 426 to securely hold the wiring, (e.g. 18# or 20# SPT1W or XTW wire) in place relative to the J-hook 414 by the detent's 426 position in a middle seam of the wire, and also detent 426 may act as a stop for SPT2W to hold it securely (similar to 412). Since the wire is turned vertically, the socket extends horizontally in this configuration.

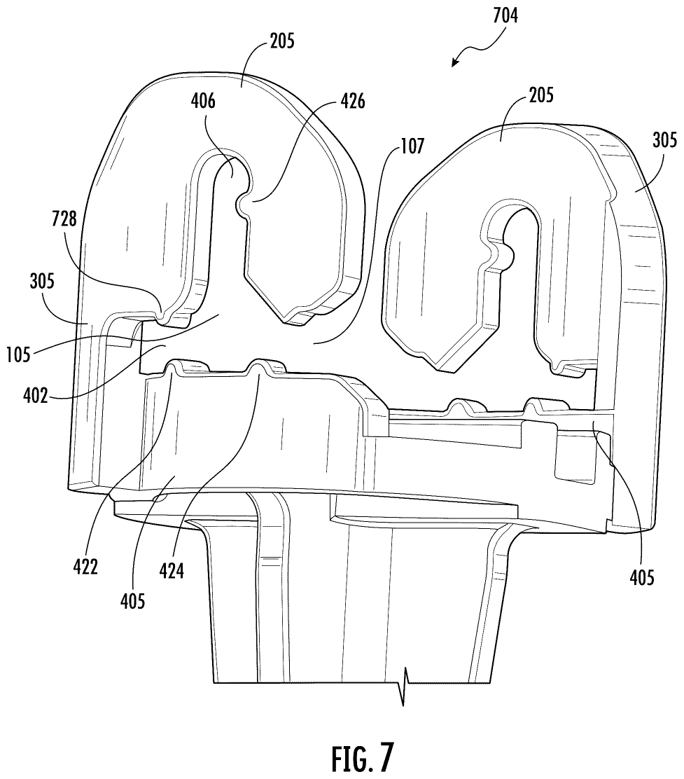

As shown in FIGS. 4-6, detents are positioned on one side of respective slots (e.g. 402, 406). However, according to aspects of the present invention, detents are positioned on opposite sides of the vertical 206, 406 and horizontal 202, 402 slots and hold, for example, wire positioned in between the seams of the wire on both sides. For example, with reference to FIG. 7, an alternative lamp holder 704 includes components described above in addition to a fourth detent 728 in a horizontal slot 702 to retain the wire in place when seated on wire 422 further securing a 18#/20# SPT1W/XTW wire in place when seated horizontally, thus limiting wire movement.

The lamp holder configurations according to the present invention provide different wiring orientations contributing to its versatility. For example, depending on the height and location of the detents, the detents are configured to hold the wire in between adjacent detents and/or positioning the wire seam over the detent. As another example, the slots do not include the detents and, instead, have narrowing the slots to accommodate various wire sizes, for example, SPT1 and SPT2 size wires (for wet or dry conditions). In use, the wiring is released by applying force to the wiring, J-hook, or both.

Continued reference to FIG. 4 illustrates a bottom channel 432 formed between flanges or side walls 436 and openings or drains 442. Drains 442 provide drainage for standing condensation or water beneath a bulb socket 302. For example, when a socket 302 is seated in an upright or axial orientation, the socket 302 drains from one or both of the wire sides and/or weep holes or drains 442 in the base. Side walls 436 hold the socket above drain holes. According to one aspect of the present invention, at least one flange or side wall 436 is provided to elevate the socket 302 above the base 110 to facilitate draining with or without the inclusion of drains 442. For certain sockets with integrated clips, channel 432 holds the integrated clip when the socket 302 is seated in a horizontal orientation. The channel 432 permits water to drain from the base of a socket 302 that has weep holes when seated in a vertical fashion.

FIG. 6 is a top plan view of a lamp holder having J-hooks 414 shown in FIGS. 4 and 5. As shown in FIG. 6, the J-hooks 414 are selectively positioned to be offset from one another radially, that the J-hooks 414 include an upper portion 414B which is radially offset from lower portion 414A. This configuration is selectively utilized for manufacturing efficiencies and for facilitating easier wiring insertion.

Another aspect of the present invention is shown FIG. 8. The lamp holder 804 includes J-hooks 814 having the vertical slot 806 and horizontal slot 802 (shown with wire 805 inserted) intersect. An inboard edge 872 and outboard edge 874 include curved profiles to facilitate smoother turns of the socket wire 805 into the vertical slot 806, and vice versa. Additionally, and separable from the modified edges 872, 874, the vertical slot 806 top terminal 878 is generally linear and, as shown, by way of example, is configured as a square. This advantageous benefit of the present invention also is achieved when the clip is provided as shown in FIG. 8. The arm 900 shown in FIG. 8, when the socket 804 is rotated, does not interfere with the ability of the socket 802 to be rotated in either direction because the arm 900 is received by the channel 432. It is within the scope of the present invention that a rounded top terminal is provided similar to that shown in various other Figures.

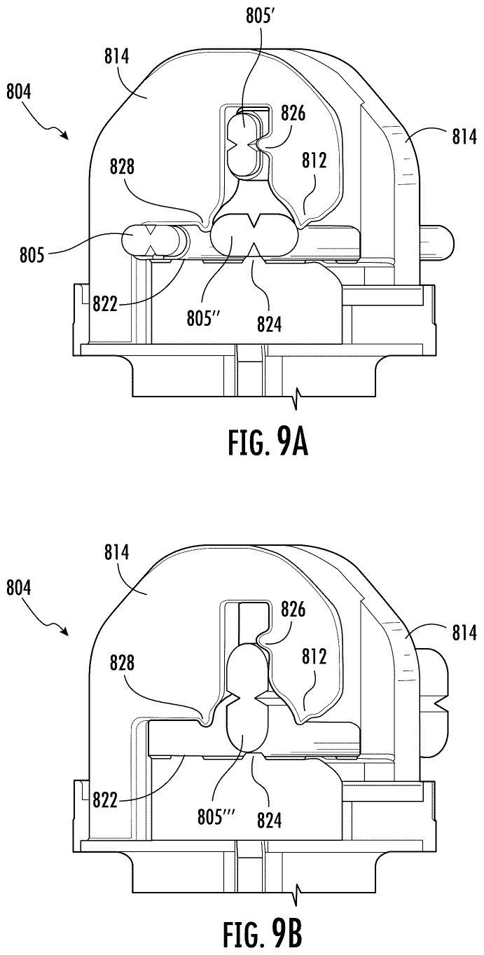

FIGS. 9A and 9B depicts the lamp holder 804 of FIG. 8 without the socket and illustrates various arrangements of wiring and wiring sizes in the slots. Exemplary wire 805 in FIG. 9A shows two wire sizes, wherein the inner wire 805 is 20# wire and the outer wire 805″ is 18# wire (SPT1W or XTW) in a first horizontal position. Wire 805 sits on top of detent 822 and held by detent 828. FIG. 9A shows wire 805′ on one wire sizes in one vertical position wire 805′ is held by detent 826 and an opposed side of the vertical slot 806) and FIG. 9B shows wire 805′″ of a second, larger size, in another vertical position. In this position, wire 805″ sits on top of fifth detent 824 and held in between fourth detent 828 and detent 812. Wiring 805″, for example, is an 18# SPT2W wire in horizontal position in FIG. 9A and a vertical position in FIG. 9B. When wire 805′″ is rotated into the vertical slot, modified edges 872, 874 (FIG. 8) eases the transition of the wire 805′″ into vertical and detent 826 resists the wire riding upward.

While exemplary embodiments have been shown and described above for the purpose of disclosure, modifications to the disclosed embodiments may occur to those skilled in the art. For example, options include further securing the wiring in and/or out of the socket holders, whether from the sides underneath (whether reinforced by attaching them together or not) and removing the base plate. Further, other or additional embodiments could include a small locking piece at the wire entrance that will open when force is placed against it and close once the wire is inserted further securing the wiring in position especially with different sizes of wiring. The disclosure, therefore, is not limited to the above precise embodiments and rather is understood to include embodiments or modifications without departing from its spirit and scope of the disclosure.

What is claimed is:

1. A lamp holder apparatus having a longitudinal axis comprising:
a lamp holder;
a light bulb socket configured to support a light bulb, said light bulb socket having wiring extending outwardly from sides thereof wherein said light bulb socket is selectively received by said lamp holder in more than one orientation;
wherein said lamp holder comprises a base having a first and second side edges and a first and second J-hook wherein said first and second J-hooks extend perpendicular to said base and wherein said first and second J-hooks define a wire entry port in open communication with a wire receiving cavity wherein said wire receiving cavity includes a horizontal portion extending from said wire entry port, substantially parallel to said base, and a vertical portion which intersects said horizontal position, said vertical portion extending generally perpendicular to said base, and wherein said horizontal and vertical portions are in open communication with said wire entry port;
wherein said first wire entry port of said first J-hook faces in a first direction and said second wire entry port of said second J-hook faces in a second direction wherein said first and second directions are opposite each other and wherein said first and second J-hooks extend from said first side of said base on opposing side edges thereof and wherein said first J-hook wire receiving cavity and said second J-hook wire receiving cavity are positioned in general alignment in a radial direction to receive said light bulb wiring; and
wherein said light bulb socket is selectively oriented in a first direction substantially perpendicular to said base and said light bulb socket wiring is received in said first and second horizontal portions and said light bulb socket is selectively oriented in a second direction, transverse to said first direction, wherein said light bulb socket wiring is received in said first and second vertical portions and movement of said wiring within said first and second wire receiving cavities enables said light bulb socket to move between said first and second directions with said wiring remaining within said first and second cavities.

2. The lamp holder apparatus according to claim 1 further comprising a lamp holder apparatus support wherein said lamp holder is connected to said apparatus support for supporting said lamp holder apparatus in a selective location.

3. The lamp holder apparatus according to claim 2 wherein said lamp holder is connected to a proximal end of said apparatus support and said apparatus support extends distally from said lamp holder.

4. The lamp holder apparatus according to claim 3 wherein said apparatus support is a stake.

5. The lamp holder apparatus according to claim 2 wherein said lamp holder is non-movably connected to said apparatus support.

6. The lamp holder apparatus according to claim 1 wherein said base is defined by a front edge, a rear edge, and said opposing side edges extend between said front and rear edges wherein said first and second J-hooks are aligned radially to the longitudinal axis of said lamp holder apparatus.

7. The lamp holder apparatus according to claim 1 wherein said first and second J-hooks extend from opposing side edges of said base so as to be radially offset.

8. The lamp holder apparatus according to claim 1 wherein said first and second J-hooks includes a proximal hook, a longitudinal support extending from said proximal hook, and a lateral support for connecting said J-hook to said base wherein said proximal hook and said longitudinal support define said first and second vertical portions of said first and second wire receiving cavities, and said longitudinal support and said lateral support define said first and second horizontal portions of said first and second wire receiving cavities.

9. The lamp holder apparatus according to claim 8 wherein said proximal hook extends from said longitudinal support in a first longitudinal axis and said lateral support extends from said longitudinal support in a second longitudinal axis different from said proximal hook first longitudinal axis.

10. The lamp holder apparatus according to claim 8 wherein said proximal hook includes an angled surface adjacent said wire entry port.

11. The lamp holder apparatus according to claim 1 wherein said first and second J-hooks includes a proximal hook defining said first and second vertical portions of said first and second wire receiving cavities and said proximal hook includes a first detent extending in a direction facing said wire entry port.

12. The lamp holder apparatus according to claim 1 wherein said first and second J-hooks includes a proximal hook defining said first and second vertical portions of said first and second wire receiving cavities and said proximal hook includes a second detent extending in a direction facing said vertical portion.

13. The lamp holder apparatus according to claim 1 wherein said first and second J-hooks includes a lateral support extending along said base wherein said longitudinal support includes a third detent extending into said horizontal portion.

14. The lamp holder apparatus according to claim 13 wherein said third detent is positioned adjacent said wire entry port.

15. The lamp holder apparatus according to claim 1 wherein said first and second J-hooks includes a proximal hook defining said first and second vertical portions of said first and second wire receiving cavities and said proximal hook includes a fourth detent extending in a direction facing said horizontal portion of said wire receiving cavity.

16. The lamp holder apparatus according to claim 1 wherein said first and second J-hooks includes a lateral support extending along said base wherein said longitudinal support includes a fifth detent extending into said horizontal portion and facing said vertical portion of said wire receiving cavity.

17. The lamp holder apparatus according to claim 1 wherein said base of said lamp holder defines at least one flange extending proximally from said first side of said base wherein said light bulb socket is supported by said flange so as to be elevated from said first side of said base.

18. The lamp holder apparatus according to claim 17 wherein said base comprises two of said at least one flange wherein said two flanges extend along said base parallel to one another and define a channel therebetween.

19. The lamp holder apparatus according to claim 18 wherein said base further includes a drain.

20. The lamp holder apparatus according to claim 1 wherein said base further includes a drain defined by an aperture.

21. A method of orientating a lamp socket in a lamp holder apparatus in more than one direction comprising the steps of:
providing a lamp holder apparatus comprising a lamp holder and a light bulb socket configured to support a light bulb, said light bulb socket having wiring extending outwardly from sides thereof wherein said light bulb socket is received by said lamp holder in more than one orientation, wherein said lamp holder comprises a base having a first and second side and a first and second J-hook wherein said first and second J-hooks extend perpendicular to said base and wherein said first and second J-hooks define a wire entry port and a wire receiving cavity wherein said wire receiving cavity includes a horizontal portion extending from said wire entry port, substantially parallel to said base, and a vertical portion which intersects said horizontal position, said horizontal and vertical portions both in open communication with said wire entry port;
positioning said wiring in one of said vertical and horizontal portions to orient said light bulb socket in a first direction;
moving said wiring from said one of said vertical and horizontal portions into a second of said vertical and horizontal portions to reorient said light bulb socket in a second direction, transverse to said first direction, enabling said light bulb socket to move between said first and second directions with said wiring remaining within said wire receiving cavity.
